(19) United States
(12) Patent Application Publication
(10) Pub. No.: US 2005/0226711 A1
(43) Pub. Date: Oct. 13, 2005

(54) Process and device for handling objects

(76) Inventors: Bernd Schnoor, Friedberg (DE); Christian Wurll, Grobenzell (DE)

Correspondence Address: MCGLEW & TUTTLE, PC, P.O. BOX 9227, SCARBOROUGH STATION, SCARBOROUGH, NY, 10510-9227, US

(21) Appl. No.: 10/981,252

(22) Filed: Nov. 4, 2004

(30) Foreign Application Priority Data
Nov. 8, 2003 (DE) 103 52 279.4

(51) Int. Cl. B66C 1/00

(52) U.S. Cl. 414/736

(57) ABSTRACT

A process for handling objects, such as packages, by means of a materials handling device, such as a multiaxial industrial robot, with a gripping means, is characterized in that coordinates of a position, dimension and/or orientation of a number of objects are first determined, and individual gripping elements of the gripping means are subsequently actuated on the basis of the coordinates for gripping the objects. A gripping means, in which gripping elements can be activated and deactivated individually, is used according to the present invention in the course of the above-mentioned process. Handling operations, for example, commissioning processes, can thus be optimized in terms of the duration of the process.

The present invention pertains to a process for handling objects, such as packages, by means of materials handling devices, such as a multiaxial industrial robot, with a gripping means. Furthermore, the present invention pertains to a gripping means with an arrangement of gripping elements for handling objects, which can be moved by means of a materials handling device, such as a multiaxial industrial robot, for gripping the objects.

Processes and devices of the type mentioned in the introduction are nowadays used, among other things, for handling tasks in the form of commissioning processes. “Commissioning” is defined here especially as the automatic depalletization of packages located on or in a storage carrier, e.g., a pallet, crate, box or the like and the loading (compilation) thereof onto (on) another storage carrier. For example, the storage carriers may be arranged to the left and right of a storage aisle, while the materials handling device is displaceable in the storage aisle. The storage carriers are usually loaded with identical packages. Such a loading is called “single-type” loading; however, the storage carriers may also be loaded with different types of goods, in which case packages or different sizes are located on or in the storage carrier. Only a few packages of a certain article are usually needed from a certain storage carrier during the commissioning process. To reduce nonproductive (travel) times in the process, commissioning orders are “condensed,” i.e., put together, so that more than only one package is depalletized from one storage carrier in respect to a so-called order stack (batch), if this is necessary and possible. The nonproductive time, e.g., the travel from one storage carrier to the other, can thus be considerably reduced.

The depalletization of pallets containing one type of articles is usually performed by individual gripping, e.g., with so-called suction mat grippers. The suction mats used are adapted to the particular size of the objects to be depalletized, and it is possible to change over between suction mats of different sizes as needed. Depending on the sensor system, the materials handling device grips the particular object, if possible, centrally, and deposits same in another location in a defined manner, e.g., on a conveyor belt. The orientation of the gripping means is always adapted to an actual orientation of the package during gripping. Corresponding gripping means are known, for example, from U.S. Pat. No. 5,984,623 and U.S. Pat. No. 4,789,295. In particular, it can be considered to be disadvantageous in this connection that the handling of objects is always possible by individual gripping only, and that additional process time is lost due to the necessary gripper change in case of changes in the dimensions of the objects. Furthermore, suction mat gripping systems are known that have a plurality of suction means and in which suction means not needed for handling an object can be automatically closed depending on a volume flow. It can be considered to be disadvantageous here, in particular, that besides an object to be gripped, additional packages may be unintentionally gripped as well. Finally, there are gripper systems with an arrangement of suction elements in which subgroups of suction elements of a permanently preset geometry can be actively actuated by means of valves. Such systems have the drawback that only a greatly limited variety of objects can be gripped under certain, exactly defined boundary conditions.

The basic object of the present invention is to improve a process and a device of the type described in the introduction such that a plurality of objects of different dimensions, positions and/or orientations can be handled in a flexible manner in one operation for the purpose of saving time. The object is accomplished in a process of the type mentioned in the introduction by first determining coordinates of a position, dimension and/or orientation of a number of objects and subsequently actuating individual gripping elements of the gripping means for gripping the objects on the basis of the coordinates. To accomplish the object, provisions are made in a gripping means of the type described in the introduction for the gripping elements to be able to be activated and deactivated individually.

Due to the possibility of the individual active actuation of individual suction elements, an advantageous flexible multiple gripping can be achieved during the depalletization of objects. Moreover, it becomes unnecessary to change the gripper even in case of objects of greatly different sizes thanks to the active actuation of the gripping elements because the dimension of the gripping means is variable as a result, as a result of which nonproductive process times are eliminated and the economy of the overall system is increased. Thus, as a statistical mean, the cycle time can be considerably reduced during depalletization within the framework of the present invention, as a result of which the throughput of articles per system increases correspondingly.

In a variant of the process according to the present invention, provisions are advantageously made for determining a number of objects that can be gripped together as a function of the coordinates of the objects. To also make it possible to take into account irregular orientations of objects, an extremely preferred variant of the process according to the present invention provides for the objects being gripped sequentially. To nevertheless deposit the gripped objects in an orderly manner, the gripping means is preferably reoriented after an object has been gripped. The gripped objects can then be deposited sequentially. Provisions are made in this connection in another embodiment of the process according to the present invention for a reorientation of the gripping means to take place prior to the deposition of an object.

To make it possible to respond to variable positionings, dimensions and orientations of the objects in a flexible manner, provisions are made within the framework of an extremely preferred variant of the process according to the present invention for the coordinates of the objects to be determined by means of a sensor means arranged at the materials handling device and/or the gripping means. In addition or as an alternative, the coordinates of the objects can also be preset by an external geometry unit, such as a CAD system.

Furthermore, individual gripping elements can be switched to the inactive state in a variant of the process according to the present invention, e.g., in case of malfunction, so that a reliable and defined access of the gripping means is guaranteed at any time.

In a gripping means according to the present invention, the gripping elements are preferably arranged in the form of a two-dimensional matrix. Highly flexible adaptability to different object shapes and orientations is achieved due to the arrangement of the gripping elements in a matrix form according to the present invention. Provisions are made in this connection for at least a number of gripping elements to be designed as suction grippers or mechanical gripping elements, such as hook type grippers or the like.

To guarantee that the materials handling operation is a reliable and defined operation at any time, individual gripping elements are preferably able to be deactivated, especially in case of malfunction.

To make it possible to use the gripping means according to the present invention in case of irregular and/or variable positioning or orientation of the object as well, a variant of the said gripping means has a sensor means for determining the positions, dimensions (such as length and width) and/or orientations of the objects. In addition or as an alternative, an external geometry unit may also be present for presetting the positions and/or orientations of the objects.

Other properties and advantages of the present invention will appear from the following description of an exemplary embodiment on the basis of the drawings. In the drawings,

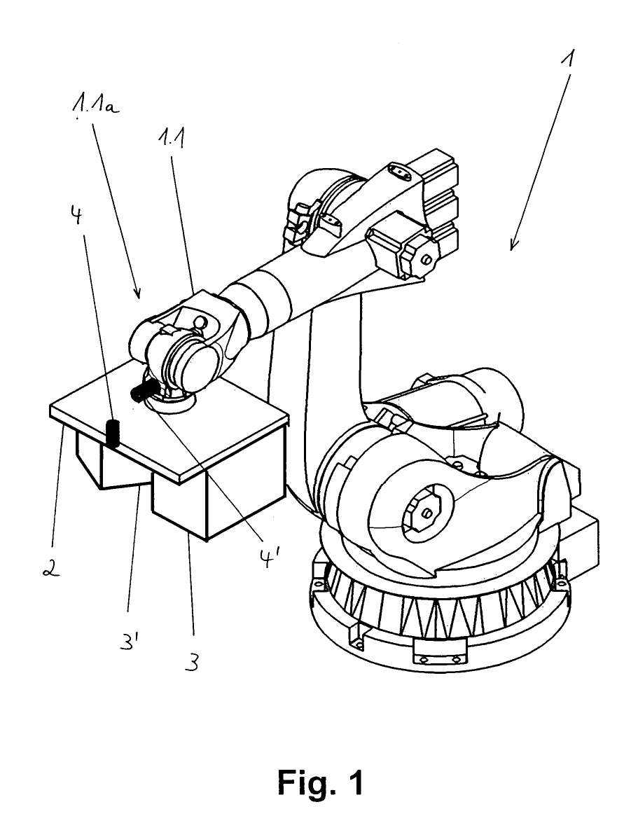

FIG. 1 shows a perspective view of a handling device with a gripping means and gripped objects;

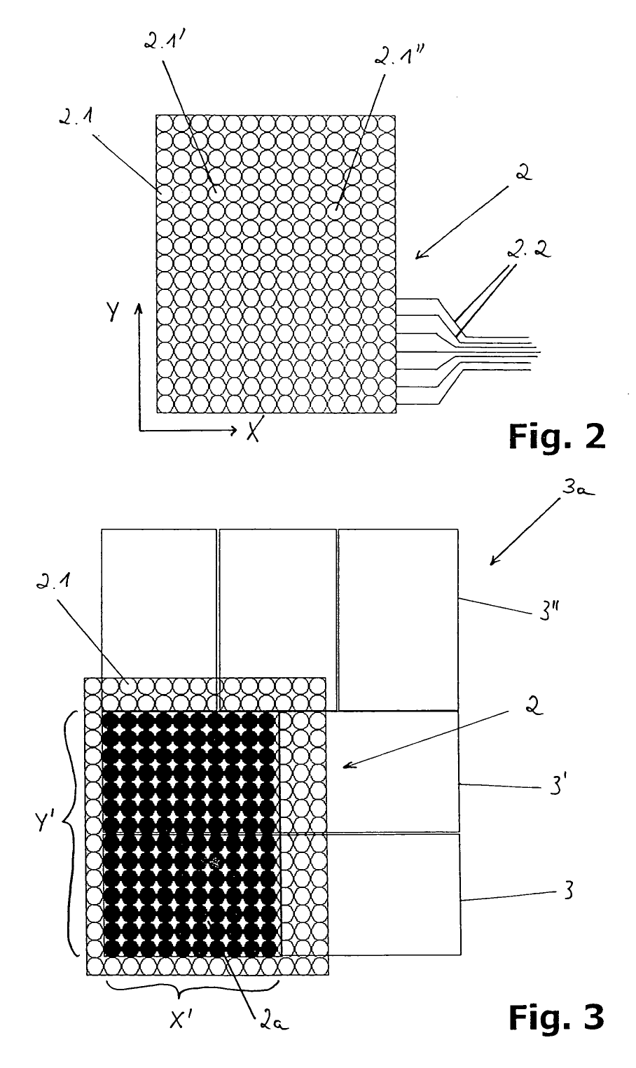

FIG. 2 shows a schematic top view of a gripping means according to the present invention;

FIG. 3 shows a gripping means according to the present invention for gripping a plurality of regularly oriented objects;

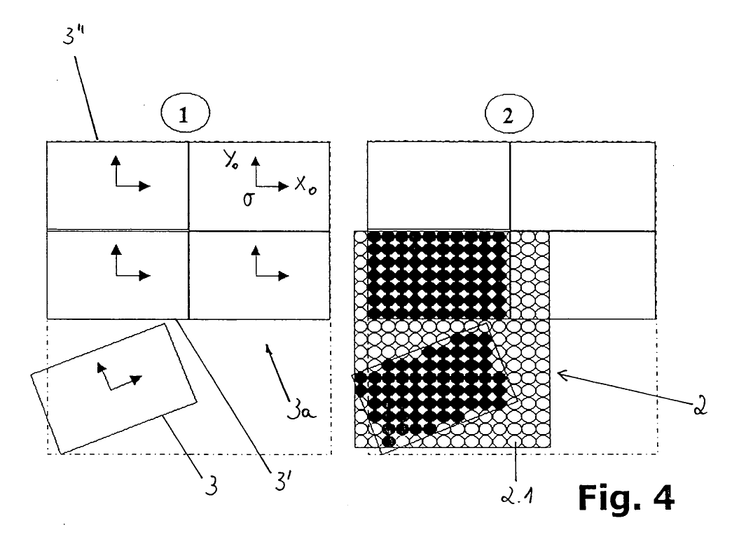

FIG. 4 shows a gripping means according to the present invention during the gripping of a plurality of irregularly oriented objects;

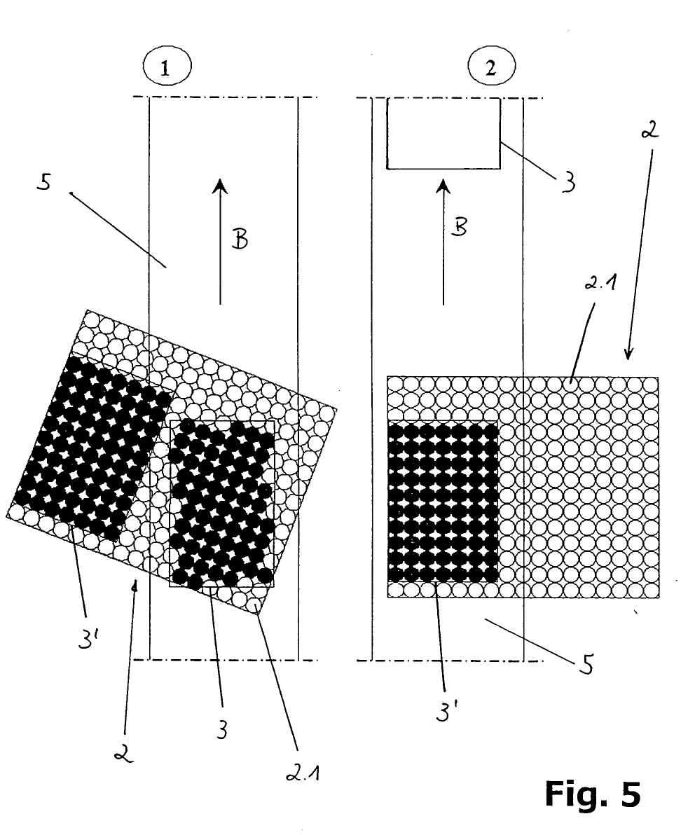

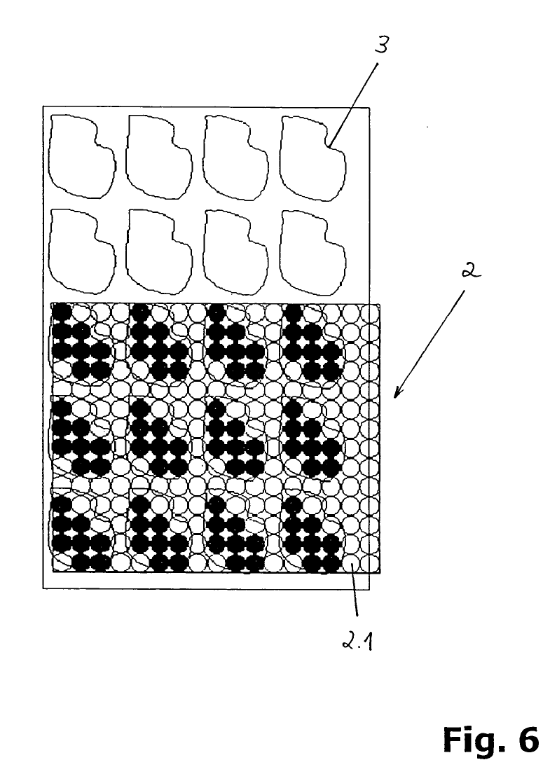

FIG. 5 shows a gripping means according to the present invention for gripping a plurality of objects of irregular shape;

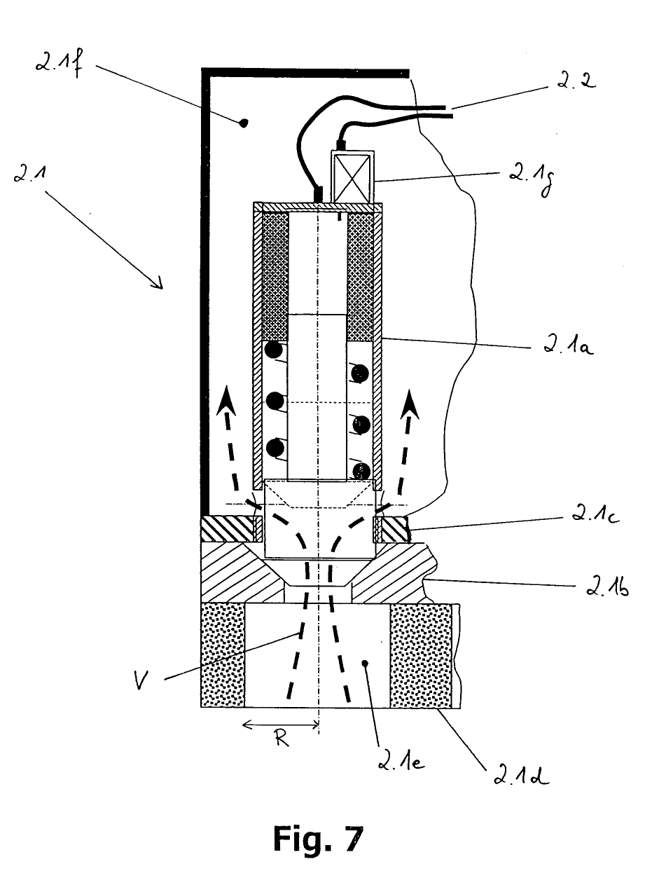

FIG. 7 shows a longitudinal section through a gripping element of a gripping means according to the present invention; and

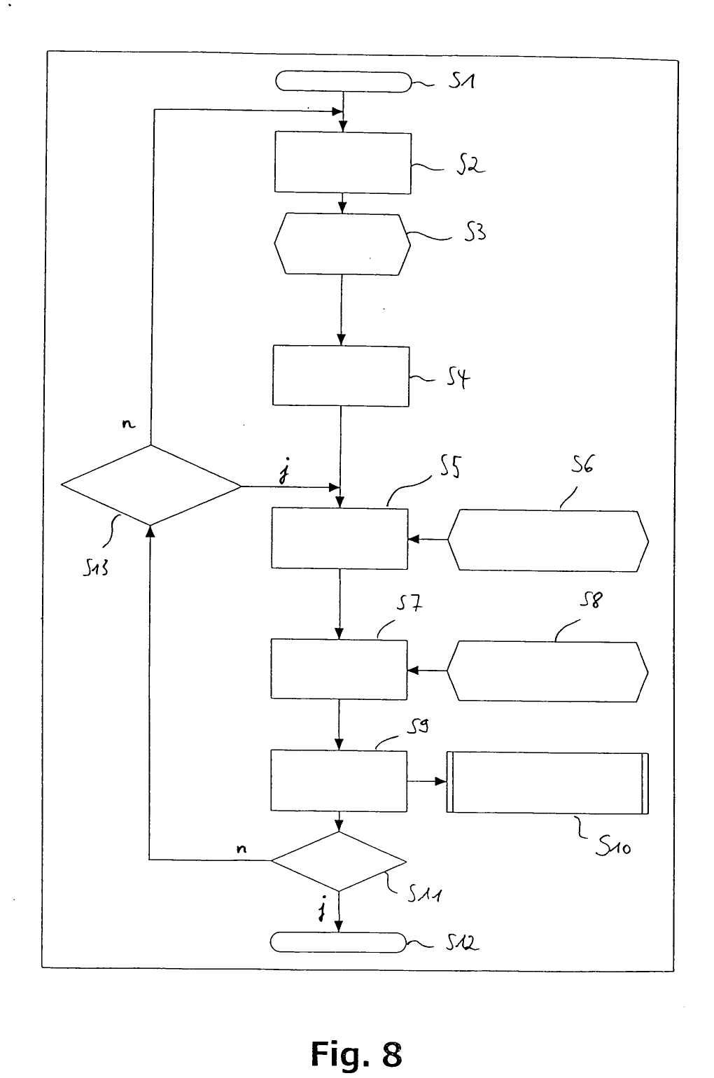

FIG. 8 shows a flow chart of the process according to the present invention.

FIG. 1 shows a schematic side view of a materials handling device in the form of a multiaxial industrial robot 1, hereinafter called robot for short, which has, at a distal end 1.1a of a robot hand 1.1, a gripping means 2 according to the present invention for handling objects 3, 3′, which will hereinafter be called packages. As will be shown in even greater detail on the basis of the following figures, the gripping means 2 has a plurality of gripping elements, which can be actuated individually and whose individual actuation is performed, for example, by a control means (not shown) of the robot 1. Furthermore, a sensor means 4 or 4′, e.g., a camera or the like, by means of which information can be determined concerning the objects 3, 3′ such as their geometric dimensions and preferably transmitted to the robot control, is arranged at the gripping means 2 and/or at the robot 1 itself.

FIG. 2 shows a schematic top view of a gripping means 2 according to the present invention, which has a plurality of individual gripping elements 2.1, which are advantageously arranged in the form of a two-dimensional matrix. The rows of the matrix have an extension in a first direction X in space, while the columns of the matrix extend in the direction of a second direction Y in space that extends at right angles to the first direction X in space. According to the present invention, the gripping elements 2.1 may be, for example, suction grippers or mechanical grippers, such as hook type grippers or the like.

FIG. 3 shows the use of the gripping means 2 according to the present invention according to FIG. 2 during the gripping of a plurality of regularly arranged packages 3, 3′, 3″ of the same type. A selection 2a of gripping elements 2.1 of the gripping means 2 is selected for this purpose and actively actuated for gripping the packages (black circles), while the other gripping elements 2.1 remain inactive. An expansion X′, Y′ of the selection 2a corresponds here essentially to a corresponding expansion of the totality of packages to be gripped. The active actuation of the gripping elements 2.1 takes place according to the present invention either according to corresponding sensor data from the sensor means 4, 4′ or, as an alternative, on the basis of geometry data, which are preset by an external geometry unit, such as a CAD system.

FIG. 4 correspondingly shows the use of a gripping means 2 according to the present invention for simultaneously gripping a plurality of packages 3, 3′ when these are not oriented regularly: The positions, dimensions (such as the length and width) and/or the orientations of the packages 3, 3′, 3″ are first determined at (1) (FIG. 1). The orientation of the packages 3, 3′, 3″ is obtained from the positions of the axes X₀, Y₀ of the objects, the positions of the individual packages being determined by the position of the corresponding origin 0. How the two packages 3, 3′ are gripped simultaneously by multiple gripping and depalletized with the gripping means 2 according to the present invention and its gripping elements 2.1, which can be actuated individually, is determined in (2). The actuation of the corresponding gripping elements 2.1 is performed after a coordinate transformation into the system of coordinates of the gripping means 2, as will be explained below on the basis of FIG. 8.

It is shown on the basis of FIG. 5 how the possibility of a sequential and oriented deposition of objects 3, 3′, which were picked up according to FIG. 4 by an irregular multiple gripping, is obtained due to the use of the gripping means 2 according to the present invention:

FIG. 5 shows a conveying means 5 in the form of a conveyor belt with the direction of conveying B at two consecutive times (1), (2). At (1), the first package 3 is deposited on the conveyor belt in the oriented form, i.e., with the object axes X₀, Y₀ of the said object being oriented in the direction of movement B of the conveying means 5, by switching the corresponding gripping elements 2.1 into the inactive state after the orientation of the object 3. After the subsequent reorientation of the gripping means 2 by means of the robot 1 (FIG. 1), the second object 3′ is deposited in (2) on the conveying means 5, likewise in the oriented form, by deactivating the corresponding gripping elements 2.1. The sequential and oriented deposition of the objects 3, 3′ shown in FIG. 5 is possible because the relative position and orientation of the objects 3, 3′ in relation to the gripping means 2 are known from the sensor means 4, 4′ (FIG. 1) or from the (CAD) data made available by an external geometry unit.

FIG. 6 shows the use of a gripping means 2 according to the present invention during the handling of irregularly shaped objects, for example, cut-out parts, such as sheet metal parts, during laser or water jet cutting as well as plastic, paper or wood parts during cutting or sawing.

FIG. 7 shows the longitudinal section of a possible embodiment of the gripping elements 2.1. This is the embodiment of the gripping elements 2.1 preferred according to the present invention in the form of vacuum matrix grippers (suction grippers). In its embodiment preferred according to the present invention corresponding to FIG. 7, the gripping element 2.1 has a magnetic seat valve 2.1a of a design which is known per se, which is screwed into a holding plate 2.1c arranged above a valve seat plate 2.1b. Furthermore, a suction mat 2.1d, which has an opening 2.1e with a radius R under the valve 2.1a, is arranged under the valve seat plate 2.1b. The suction mat 2.1d is preferably made of plastic according to the present invention and has a hole matrix or a honeycomb pattern. Consequently, the totality of the openings 2.1e of all gripping elements 2.1 leads to the (hole) matrix pattern of the gripping means 2 according to the present invention.

The magnetic seat value 2.1a is arranged within a vacuum chamber 2. If to generate the vacuum necessary to grip objects. Furthermore, lines 2.2 for actuating the valve 2.1a or a sensor 2.1g present in same for displaying a closed state of the valve 2.1a can be recognized in the upper part of FIG. 7.

The magnetic seat valve 2.1a and consequently the gripping element 2.1 according to the present invention are preferably designed such that an automatic (passive) closing of the valve 2.1a takes place in case of an excessive volume flow V through the opening 2.1e intro the vacuum chamber 2.1f. As a result, an unintended, incorrect activation of individual gripping elements 2.1 is avoided, for example, when these are located at the very edge of a package to be gripped and thus lead to increasing pressure in the vacuum chamber 2. If because of the intake of ambient air, as a result of which the overall holding force of the gripping means 2 would be reduced. The valve 2.1a shown as an example in FIG. 7 may, of course, have a plurality of other, prior-art designs; for example, it may be a ball valve or the like. However, every individual valve 2.1a and consequently every gripping element 2.1 can be actuated individually and independently via the lines 2.2 in any case.

FIG. 8 shows the course of a process according to the present invention for handling objects in a detailed form on the basis of a flow chart: After the start of the process according to the present invention in step S1, transfer and determination of the individual positions of all specific individual objects 3-3″ take place in step S2 (cf. FIGS. 3-6) in a working area of the materials handling device 1 and of the gripping means 2 (FIG. 1; area of interest). The coordinates and orientations can be made available in step S3, among other things, by a CAD system or they can also be determined—optionally additionally—by means of the sensor means 4, 4′ at the gripping means 2 or at the robot 1. The sensor means 4, 4′ may be especially an image recognition system, such as a camera.

The coordinates and orientations, i.e., six degrees of freedom, are transformed in step S4 to the system of coordinates of the robot 1 and the gripping means 2 by means of a suitable program engineering means (transformation algorithm), preferably in the control means of the robot 1. As a result, the relevant positions and orientations of all individual objects 3-3″ will later be known in reference to the gripping means 2. This makes possible, among other things, the sequential and oriented pick-up and deposition of individual objects, as described above in detail on the basis of FIG. 5.

Another program engineering means (matching algorithm) subsequently calculates in step S5 an optimal number of necessary gripping cycles to be performed by means of the robot 1 or the gripping means 2. The said optimal number is usually the lowest possible number of necessary gripping cycles. The calculation (step S5) takes place with the inclusion (step S6) of the following parameters:
Number of objects to be gripped;
relative position and orientation in space of all individual objects in the working area; and
geometry of the gripping means 2 (usually length (X) x width (Y)) as well as the geometry of an individual gripping element 2.1 (e.g., radius R of an opening 2.1e; FIG. 7) and the geometric arrangement thereof as a matrix.

Sequential and oriented pick-up of the objects may also be taken into account in the calculation in order to optimally utilize the gripping means 2 and to reduce the number of gripping cycles in this manner. The corresponding gripping element, for example, a valve 2.1a of a vacuum gripping element with suction function (FIG. 7), is actuated according to the present invention wherever an individual gripping element and an object to be gripped overlap.

The gripping and deposition positions determined are subsequently transmitted in manipulator coordinates to another program engineering means, the so-called parser. Based on these coordinates, the parser automatically generates the movement program for the robot 1 in step S7. Additional space coordinates can also be included in the movement program of the robot in step S8. These so-called supporting points take into account the geometry of the robot's environment in order to thus prevent collisions of the robot with other objects in its environment. The movement program of the robot, generated in steps S7/S8, is subsequently used in step S9 by other program engineering means of the robot to carry out the materials handling operation by the robot in step S10.

According to the movement program, the robot picks up one object or a plurality of objects simultaneously or sequentially and deposits same simultaneously or sequentially. Based on the known relative position and orientation of the objects in relation to the gripping means, the picking up and optionally also the deposition may take place for every individual object in a desired orientation, i.e., in an oriented manner. The object is picked up and deposited by actuating the individual gripping elements within the gripping means (gripper matrix), which are caused to attain the necessary overlap with the objects to be gripped after the pick-up position has been reached. As was described above, complete overlap is desirable especially in case of suction elements operated according to the vacuum technique in order to prevent an unacceptable increase in pressure from occurring in the entire gripping system. Lateral gripping is necessary in case of mechanical gripping elements with frictional or nonpositive engagement in an alternative embodiment of the gripping means 2.1 according to the present invention, so that complete or partial overlap of the gripping elements with the objects may even be undesirable here.

A polling is subsequently performed in step S11 to determine whether the end of an order was reached after the performance of the action in step S10. If the result of this polling is a “Yes” (j), the process according to the present invention ends in step S12. If the result of the polling is “No” (n) in S11, a further polling is performed in step S13 to determine whether objects to be gripped are still present in the working area of the robot or the gripping means. If the result of this polling is “Yes” (j), the process is continued with step S5, as was described above. If the result of the polling S13 is “No” (n), the process is started again with step S2.

In summary, the technological procedure is consequently as follows: The positions and orientations of the packages, which are usually located in one package layer, i.e., in one plane, are recognized by means of a suitable sensor system. As an alternative, these data are provided by a CAD system. If more than one individual package is to be depalletized from the corresponding load carrier according to the commissioning order, a check is performed according to the size of the gripping means (length×width (X, Y)), the known dimensions of the packages (length×width) as well as the detected positions and orientations within the package layer to determine whether more than one package can be covered with the gripping means. In the ideal case, the number of packages covered with the gripper now corresponds to the total number of packages to be depalletized for the batch in question. The world coordinates of the gripping means and the package, which are correlated according to the present invention, will subsequently permit a corresponding actuation of the individual gripping elements (of the valve matrix), so that only the gripping elements that are located above a package to be gripped and can become fully active for the gripping operation will be activated (the valves will be opened for these gripping elements only).

### List of Reference Numbers

1 Robot
1.1 Robot hand
1.1a Distal end
2 Gripping means
2a Array of gripping elements
2.1, 2.1′, 2.1″ Gripping element
2.1a (Magnetic) seat valve
2.1b Valve seat plate
2.1c Holding plate
2.1d Suction mat
2.1e Opening
2.1f Vacuum chamber
2.1g Sensor
2.2 Line
3, 3′, 3″ Object, package
3a Array of objects
4, 4′ Sensor means
5 Conveying means
B Movement
j “yes” result of polling
n “no” result of polling
O Origin
S1-S13 Process step
X Coordinate
X₀ Coordinate of object
Y Coordinate
Y₀ Coordinate of object

1. Process for handling objects, such as packages, by means of a materials handling device, such as a multiaxial industrial robot, with a gripping means, wherein the coordinates of a position, dimension and/or orientation of a number of objects are first determined and individual gripping elements of the gripping means are subsequently actuated for gripping the objects on the basis of the coordinates.

2. Process in accordance with claim 1, characterized in that a number of objects that can be gripped together are determined as a function of the coordinates of the objects.

3. Process in accordance with claim 1, characterized in that the objects are gripped sequentially.

4. Process in accordance with claim 2, characterized in that reorientation of the gripping means is carried out after an object has been gripped.

5. Process in accordance with claim 4, characterized in that a gripped object is deposited sequentially.

6. Process in accordance with claim 5, characterized in that reorientation of the gripping means is carried out before an object is deposited.

7. Process in accordance with claim 1, characterized in that the coordinates of the objects are determined by means of a sensor means arranged at the materials handling device and/or the gripping means.

8. Process in accordance with claim 1, characterized in that the coordinates of the objects are preset by an external geometry unit.

9. Process in accordance with claim 1, characterized in that individual gripping elements are switched to the inactive state.

10. Gripping means for handling objects, which can be moved by means of a materials handling device, such as a multiaxial industrial robot, for gripping the objects, with an arrangement of gripping elements, characterized in that the said gripping elements (2.1) can be activated and deactivated one by one.

11. Gripping means in accordance with claim 10, characterized in that the said gripping elements (2.1) are arranged in the form of a two-dimensional matrix.

12. Gripping means in accordance with claim 10, characterized in that at least a number of the said gripping elements (2.1) are designed as suction grippers.

13. Gripping means in accordance with claim 10, characterized in that at least a number of the said gripping elements (2.1) are designed as mechanical gripping elements.

14. Gripping means in accordance with claim 10, characterized in that said individual gripping elements (2.1) can be deactivated.

15. Gripping elements in accordance with claim 10, characterized by a said sensor means (4, 4′) for determining the said position (O), the dimension (X′, Y′) and/or the orientation (X₀, Y₀) of the said objects (3, 3′, 3″).

16. Gripping means in accordance with claim 10, characterized by a said external geometry unit for presetting the position and/or the orientation of the said objects (3, 3′, 3″).
